(19) United States
(12) Patent Application Publication
(10) Pub. No.: US 2026/0224420 A1
(43) Pub. Date: Aug. 6, 2026

(54) LIFTING DEVICE

(71) Applicant: INTRADIN (SHANGHAI) INTELLIGENT MACHINERY CO., LTD., Shanghai (CN)

(72) Inventors: Ping LI, Shanghai (CN); Xuetao QIAO, Shanghai (CN)

(21) Appl. No.: 19/575,793

(22) Filed: Mar. 23, 2026

(30) Foreign Application Priority Data
Jan. 28, 2026 (CN) 202610116812.5

(51) Int. Cl. A61G 7/10

(52) U.S. Cl. CPC A61G 7/1019; A61G 7/1046; A61G 7/1059

(57) ABSTRACT

A lifting device includes a base, a lifting mechanism and two supporting legs. The lifting mechanism is arranged on the base. One of the two supporting legs is hinged to a first end of the base. The other of the two supporting legs is hinged to a second end of the base. The two supporting legs are configured to support the base. A spacing between the two supporting legs is adjustable. The device further includes an adjustment mechanism arranged between the two supporting legs to adjust the spacing.

### CROSS-REFERENCE TO RELATED APPLICATIONS

This application claims the benefit of priority from Chinese Patent Application No. 202610116812.5, filed on January 28, 2026. The content of the aforementioned application, including any intervening amendments thereto, is incorporated herein by reference in its entirety.

### TECHNICAL FIELD

This application relates to lifting technology, and more particularly to a lifting device.

### BACKGROUND

For some elderly people or patients with limited mobility, it is very laborious to move or stand during the rehabilitation process. As such, a lifting aid is also needed to facilitate the rehabilitation process.

In the existing lifting aids, the spacing between supporting legs of a base is designed to be non-adjustable, thereby leading to poor compatibility with users of different sizes and low flexibility. For example, for a heavy user, the fixed spacing may not provide sufficient space for the user to stand or sit; when passing through narrow passages (such as door and corner), the spacing may be excessively large to make it difficult for the equipment to travel smoothly, even damaging the surrounding environment or its structure. In view of this, this application proposes a lifting device to address such problems.

### SUMMARY

In view of this, this disclosure provides a lifting device to address the technical problems in the prior art.

A lifting device, comprising:

a base;

a lifting mechanism; and

two supporting legs;

wherein the lifting mechanism is arranged on the base; one of the two supporting legs is hinged to a first end of the base, and the other of the two supporting legs is hinged to a second end of the base; the two supporting legs are configured to support the base; and a spacing between the two supporting legs is adjustable.

In some embodiments, the lifting device further comprises an adjustment mechanism arranged on the base; wherein the adjustment mechanism is located between the two supporting legs, and is configured to adjust the spacing between the two supporting legs.

In some embodiments, the adjustment mechanism comprises a fixing block, a rotating shaft, a rotating block, a connecting rod and an operating lever; the fixing block is fixedly arranged on the base; the rotating shaft is rotatably inserted into the fixing block; a middle of the rotating block is fixedly connected to a first end of the rotating shaft; the rotating block is connected to the two supporting legs through the connecting rod; a first end of the connecting rod is hinged to the rotating block; a second end of the connecting rod is hinged to the two supporting legs; and the operating lever is fixedly connected to a second end of the rotating shaft.

In some embodiments, the adjustment mechanism further comprises a first articulated column and a second articulated column; an end of each of the two supporting legs close to the rotating block is provided with the first articulated column; two ends of the rotating block are each provided with the second articulated column; the first articulated column is connected to the second articulated column through the connecting rod; the first end of the connecting rod is movably sleeved onto the second articulated column; and the second end of the connecting rod is movably sleeved onto the first articulated column.

In some embodiments, a side of the fixing block close to the operating lever is provided with a mounting seat; the mounting seat is located below the operating lever, and is internally provided with a limiting block configured to be elastically retractable; a side of the limiting block is configured to abut against the operating lever; a surface of the operating lever close to the limiting block is provided with a plurality of slots arranged spaced apart; and

in response to a case that an end of the limiting block is engaged with a slot among the plurality of slots, the operating lever is configured to be limited by the limiting block.

In some embodiments, the side of the fixing block close to the operating lever is further provided with a limiting rod; a surface of the operating lever away from the plurality of slots is provided with an arch-shaped limiting groove; and the limiting rod is configured to extend into the arch-shaped limiting groove.

In some embodiments, the operating lever is arc-shaped, and is configured to open toward the limiting rod.

In some embodiments, each of the two supporting legs comprises a first rod body, a second rod body and a third rod body fixedly connected in sequence.

In some embodiments, at least one of the first rod body and the third rod body is configured to bend toward a direction away from the base.

In some embodiments, the lifting mechanism comprises a supporting rod, a sleeving rod, a bearing assembly and a drive mechanism; the supporting rod is vertically arranged on the base; the sleeving rod is movably sleeved onto the supporting rod; the bearing assembly is fixedly connected to the sleeving rod; and the drive mechanism is arranged on the base, and is configured to drive the sleeving rod to slide up and down along an outer wall of the supporting rod.

The present disclosure has the following beneficial effects.

The two supporting legs are respectively hinged to the first and second ends of the base, such that the spacing between two supporting legs is flexibly adjusted as needed. Moreover, when the lifting device is lifted, the stability of the lifting device is enhanced. The lifting device exhibits superior compatibility with users of different sizes and high flexibility for narrow environments, thereby improving the applicability of the lifting device in different environments.

### BRIEF DESCRIPTION OF THE DRAWINGS

In order to illustrate the technical solutions in the prior art or in the embodiments of the present disclosure more clearly, the accompanying drawings needed in the description of the prior art or the embodiments of the present disclosure will be briefly described below. Obviously, presented in the accompanying drawings are merely some embodiments of the disclosure, and other drawings can also be obtained by those skilled in the art based on these structures presented in the accompanying drawings without paying creative effort.

FIG. 1 is a three-dimensional view of a lifting device according to an embodiment of the present disclosure (from a front side);

FIG. 2 is a three-dimensional view of the lifting device according to an embodiment of the present disclosure (from a back side);

FIG. 3 schematically shows an adjustment mechanism of the lifting device according to an embodiment of the present disclosure (from a front side);

FIG. 4 is an enlarged view of portion A in FIG. 3;

FIG. 5 schematically shows the adjusting mechanism the lifting device according to an embodiment of the present disclosure (from a back side);

FIG. 6 is an enlarged view of portion B in FIG. 5;

FIG. 7 schematically shows an operating lever of the lifting device according to an embodiment of the present disclosure; and

FIG. 8 schematically shows a spacing between two supporting legs under different states of a rotating block of the lifting device according to an embodiment of the present disclosure.

In the figures: 1-base; 11-articulated portion; 12-articulated shaft; 13-reinforcing block; 2-supporting rod; 3-sleeving rod; 4-mounting block; 41-first handle; 5-bearing assembly; 51-back plate; 511-second handle; 52-bearing plate; 53-armrest; 6-drive mechanism; 61-motor; 62-telescopic rod; 63-power supply; 7-supporting leg; 71-first articulated column; 72-first rod body; 73-second rod body; 74-third rod body; 75-first mounting plate; 76-second mounting plate; 8-adjustment mechanism; 81-fixing block; 82-rotating shaft; 83-rotating block; 84-second articulated column; 85-connecting rod; 86-operating lever; 861-slot; 8611-first slot; 8612-second slot; 862-arch-shaped limiting groove; 8621-first end; 8622-second end; 87-mounting seat; 871-limiting block; 88-limiting rod; 89-bearing; and 9-omni-directional wheel.

The implementations, functional features and advantages of the present disclosure will be further illustrated with reference to the accompanying figures.

### DETAILED DESCRIPTION OF EMBODIMENTS

The technical solutions of the embodiments in the present disclosure will be described clearly and completely with reference to the accompanying drawings in the embodiments of the present disclosure. Obviously, described below are merely some embodiments of the present disclosure, instead of all embodiments of the disclosure. Other embodiments obtained by those skilled in the art based on these embodiments without paying creative efforts shall fall within the scope of the disclosure defined by the appended claims.

It should be noted that all the directional indications (such as up and down, left and right, front and back, etc.) used herein are only used to explain the relative positional relationship or motion among the components under a specific posture (as shown in the attached figure). If the specific posture changes, the corresponding directional indication will be adjusted accordingly.

Furthermore, the expressions involving "first", "second", etc. in the present disclosure are only for descriptive purposes and should not be understood as indicating or implying the relative importance or the quantity of the technical features involved. Therefore, features defined by "first" or "second" can explicitly or implicitly indicate the inclusion of at least one of such features.

In addition, with respect to the term "and / or", taking "A and / or B" as an example, it includes technical solution A, technical solution B, and a combination thereof. The technical solutions in individual embodiments can be combined with each other as long as the combined solution can be realized by one of ordinary skill in the art. If the combination of technical solutions is contradictory or unachievable, it should be considered infeasible and not fall within the scope of the present disclosure.

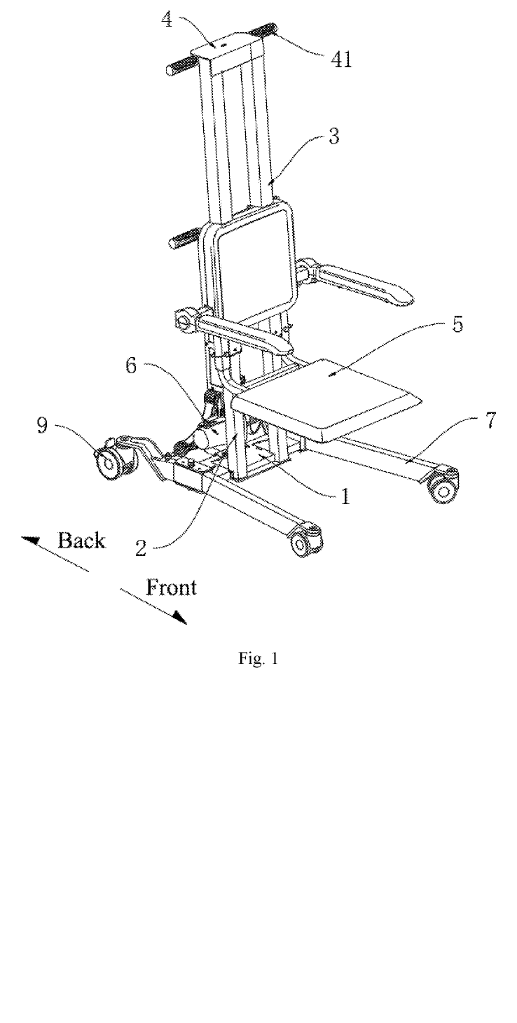

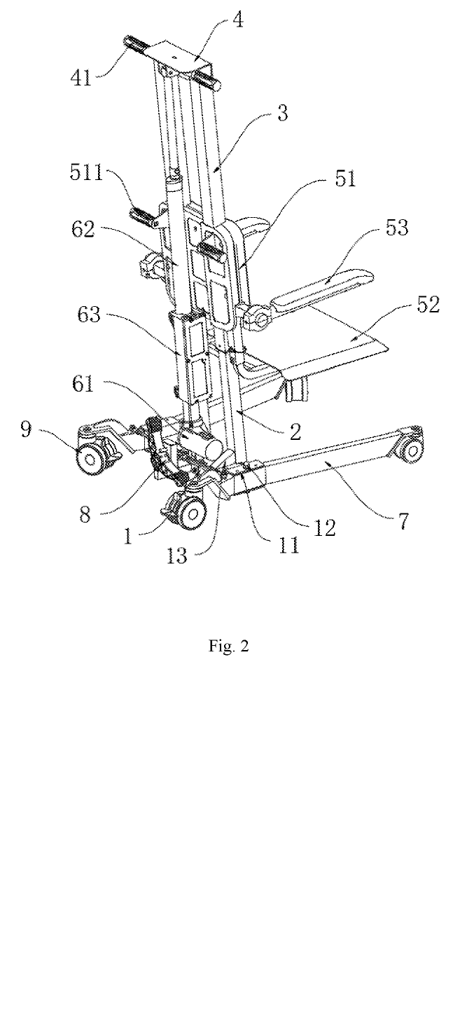

Referring to FIGS. 1-2, the present disclosure provides a lifting device, including a base 1, a lifting mechanism and two supporting legs 7. The lifting mechanism is arranged on the base 1. One of the two supporting legs 7 is hinged to a first end of the base 1. The other of the two supporting legs 7 is hinged to a second end of the base 1.

In this embodiment, the first and second ends of the base 1 are provided with an articulated portion 11, respectively. The articulated portion 11 is configured as a groove shape. When mounting, a middle of each of the two supporting legs 7 is recessed into the articulated portion 11, and is hinged to the articulated portion 11 through an articulated shaft 12. A clearance is provided between the two supporting legs 7 and an inner bottom of the articulated portion 11, so as to provide necessary space for the rotation of each of the two supporting legs 7, thereby allowing the two supporting legs 7 to smoothly rotate about the articulated shaft 12 at different angles.

In some embodiments, each of the two supporting legs 7 is configured to rotate about an articulated point of the base 1, so as to adjust a spacing between the two supporting legs 7. By adjusting the spacing, the two supporting legs 7 are soundly supported on the ground to enhance the overall stability of the lifting device. Meanwhile, when faced with users of different sizes or when used in narrow spaces, the device can better adapt to such users and environments. For example, when the user is relatively tall, the spacing can be increased to obtain more stable support, thereby preventing the device from inclining sideways during lifting due to a narrow supporting area. When the device is used in narrow spaces, such as a home doorway and a corridor corner, the spacing can be decreased to effectively reduce the horizontally-occupied space of the device, so as to allow the device to flexibly pass through the narrow spaces and improve the accessibility and practicability of the device in complex environments.

By means of such an arrangement, the spacing between the two supporting legs 7 can be flexibly adjusted as needed. This feature not only enhances the device’s stability during lifting operations but also allows it to accommodate users of varying body sizes and to operate effectively in narrow spaces, thereby improving the feasibility of the lifting device under different environments.

In some embodiments, the lifting mechanism includes a supporting rod 2, a sleeving rod 3, a bearing assembly 5 and a drive mechanism 6. The supporting rod 2 is vertically arranged on the base 1. The sleeving rod 3 is movably sleeved onto the supporting rod 2. The bearing assembly 5 is fixedly connected to the sleeving rod 3. The drive mechanism 6 is arranged on the base 1, and is configured to drive the sleeving rod 3 to slide up and down along an outer wall of the supporting rod 2.

In some embodiments, the number of the supporting rod 2 and the number of the sleeving rod 3 are both two. By means of such an arrangement, the weight capacity and the structural stability of the device are further improved, thereby facilitating a more stable lifting process. A sectional shape of the supporting rod 2 is a quadrangle, a circle, an ellipse or a regular polygon. A shape of the sleeving rod 3 is adapted to a shape of the supporting rod 2. The supporting rod 2 is welded to the base 1, or fixedly connected to it through blots in a detachable manner. The supporting rod 2 is inclined backward (i.e., in a direction away from the bearing assembly 5) at an inclined angle ranging from 4° to 10°. By setting the inclined angle, when the user sits on a bearing plate 52, the inclined design at an upper end of the supporting rod 2 counteracts or reduces user's forward-leaning tendency, preventing them from falling forward and enhancing safety. This design effectively mitigates potential forward-leaning issues during lifting, ensuring safe and reliable operation. Specific structures and arrangements of the supporting rod 2, the sleeving rod 3, the bearing assembly 5 and the drive mechanism 6 provided herein refer to the relevant description in Chinese patent No. CN 223429690U.

During operation, the sleeving rod 3 is driven to slide up and down along an outer wall of the supporting rod 2 after starting the drive mechanism 6, so as to enable the lifting of the user through the bearing assembly 5.

In some embodiments, the lifting device further includes an adjustment mechanism 8 arranged on the base 1, where the adjustment mechanism 8 is located between the two supporting legs 7, and is configured to adjust the spacing between the two supporting legs 7.

In some embodiments, when adjusting the stability of the lifting device, the adjustment mechanism 8 is in operation state to adjust the spacing between the two supporting legs 7, so as to allow the two supporting legs 7 to be better supported on the ground, thereby improving the overall stability of the lifting device. Meanwhile, when faced with users of different sizes or when used in narrow spaces, the lifting device can better adapt to such users and environments with the help of the adjustment mechanism 8 to adjust the spacing between the two supporting legs 7.

In some embodiments, a reinforcing block 13 is arranged at a connection portion between the supporting rod 2 and the base 1.

In some embodiments, the reinforcing block 13 is a triangular block to form a stable triangular supporting structure, which effectively disperses the pressure transmitted from the supporting rod 2 to the base 1, and prevents the connection portion from deformation and damage due to long-term stress.

In some embodiments, the bearing assembly 5 includes a back plate 51 and the bearing plate 52. The back plate 51 is fixedly sleeved onto the sleeving rod 3. The bearing plate 52 is fixedly arranged on the back plate 51. A preset angle is provided between the back plate 51 and the bearing plate 52.

In some embodiments, the preset angle between the back plate 51 and the bearing plate 52 is 75° to 100°. The bearing plate 52 is arranged parallel to the ground or inclined towards the ground. When the bearing plate 52 is arranged inclined towards the ground, a lowest height of the bearing plate 52 from the ground is 50 mm, which enables the user to be easily moved onto the bearing plate 52.

In some embodiments, two sides of the back plate 51 are provided with an armrest 53, respectively.

In some embodiments, a surface of the armrest 53 is arc-shaped to fit a natural curvature of user’s arm, which is convenient for the user to stabilize their body when standing or sitting. The armrest 53 is rotatably connected to the back plate 51 through bolts, further enhancing the safety and stability of the bearing assembly 5 during use.

In some embodiments, the drive mechanism 6 includes a motor 61, a telescopic rod 62 and a power supply 63. The motor 61 is fixedly arranged in the base 1. An end of the sleeving rod 3 away from the base 1 is provided with a mounting block 4. A first end of the telescopic rod 62 is drivably connected to the motor 61. A second end of the telescopic rod 62 is hinged to the mounting block 4. The power supply 63 is arranged on an outer wall of the telescopic rod 62.

In some embodiments, the motor 61 is a servo motor with forward-reverse rotation function. A telescopic length and a telescopic speed of the telescopic rod 62 are adjusted through the control system. The power supply 63 is a rechargeable lithium battery with a large capacity.

During operation, the motor 61 is configured to transmit power to the telescopic rod 62 through a gear set inside the motor 61, so as to allow the telescopic rod 62 to perform a telescopic movement. When the telescopic rod 62 extends, it pushes the mounting block 4 to drive the sleeving rod 3 to move upward, thereby lifting the sleeving rod 3 and the bearing assembly 5 fixed on the sleeving rod 3 as a whole. When the telescopic rod 62 retracts, it drives the sleeving rod 3 to move downward, achieving the lowering of the bearing assembly 5. The telescopic rod 62 has a safe voltage of 24V and a thrust force of 3000N.

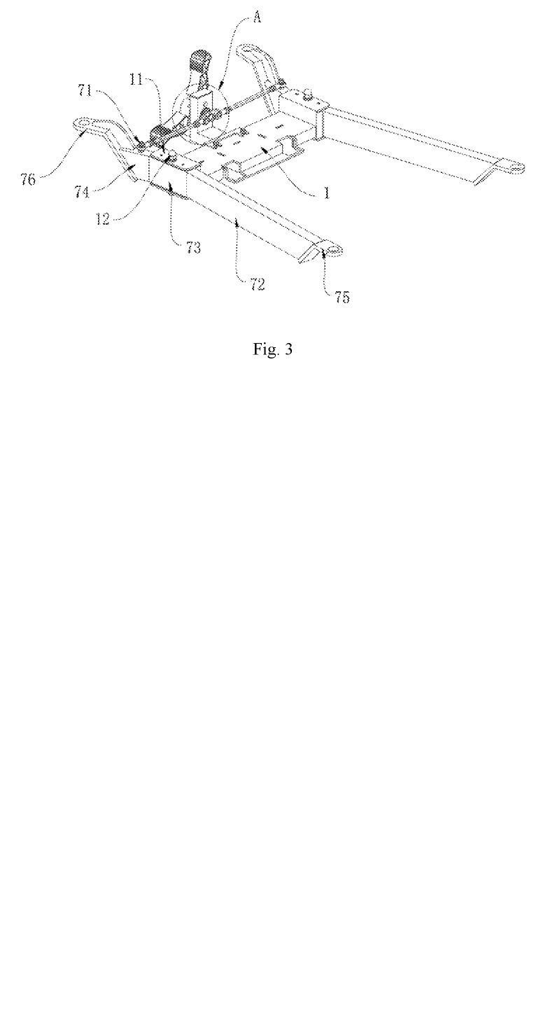

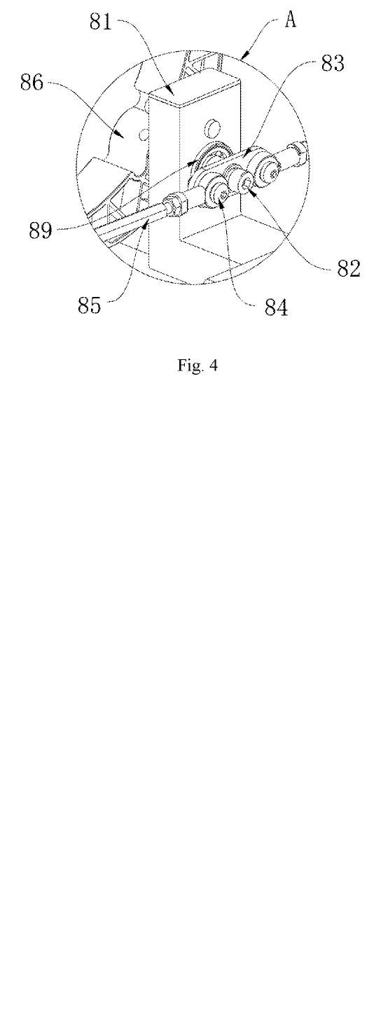

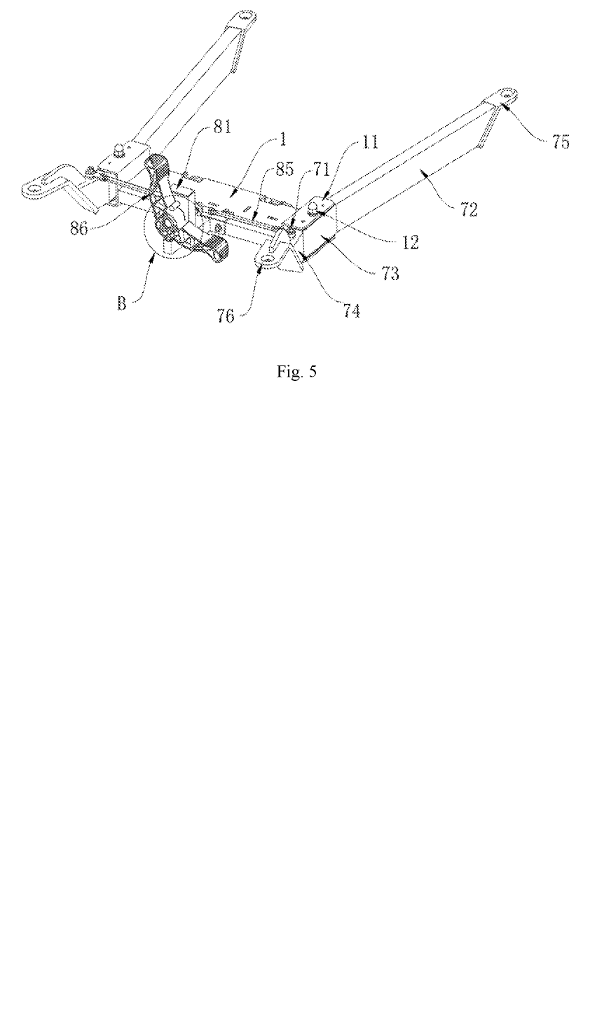

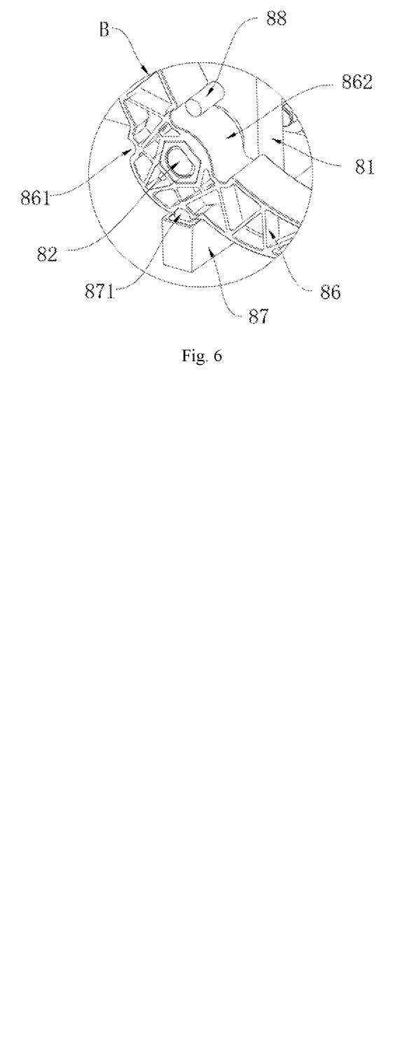

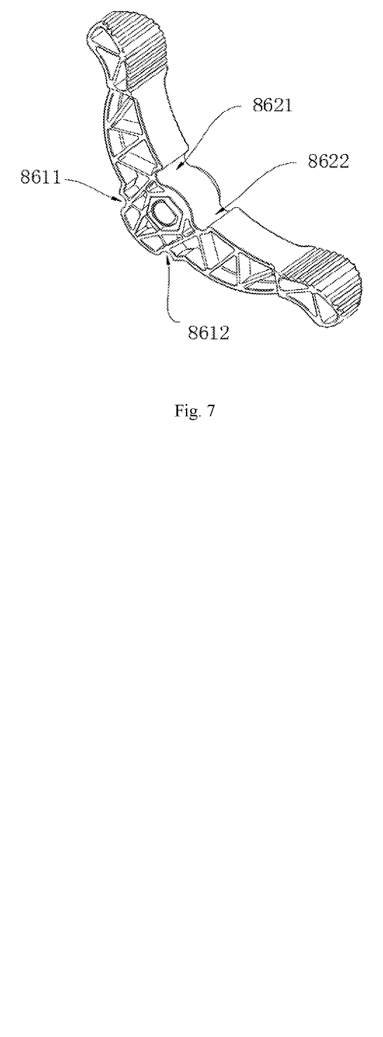

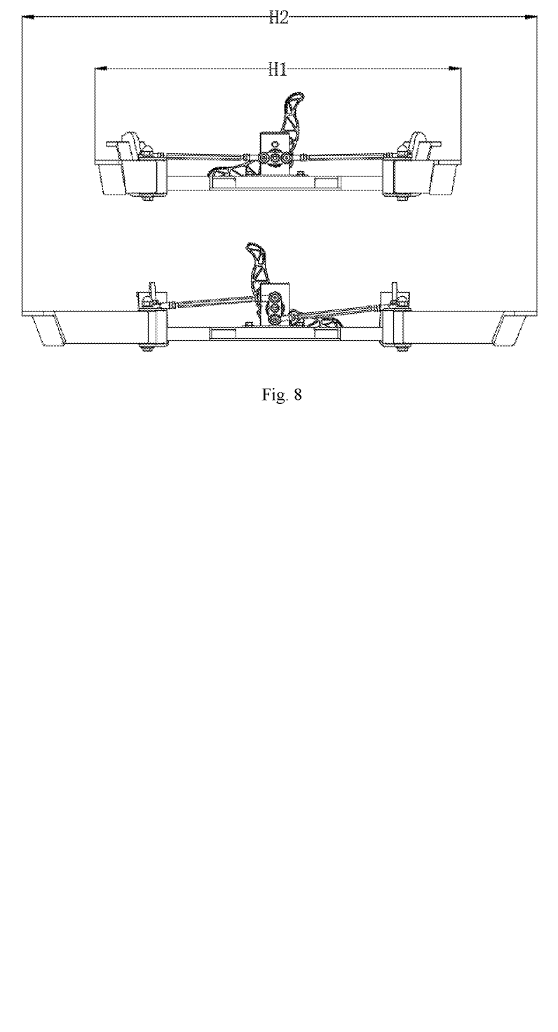

Referring to FIGS. 3-8, each of the two supporting legs 7 includes a first rod body 72, a second rod body 73 and a third rod body 74 fixedly connected in sequence. At least one of the first rod body 72 and the third rod body 74 is configured to bend toward a direction away from the base 1. The second rod body 73 is hinged to the articulated portion 11 through the articulated shaft 12.

In some embodiments, the first rod body 72, the second rod body 73 and the third rod body 74 each have a sectional shape of square. The second rod body 73 is arranged in a groove of the articulated portion 11. A clearance is provided between the second rod body 73 and a bottom of the groove of the articulated portion 11. The first rod body 72 is longer than the third rod body 74. The first rod body 72 is configured to extend towards a front of the base 1. The third rod body 74 is configured to extend towards to a rear of the base 1.

In some embodiments, there are two first rod bodies 72 extending towards the front of the base 1. The two first rod bodies 72 are configured to respectively bend toward the direction away from the base 1 to achieve a V-shaped arrangement. The V-shaped arrangement can effectively disperse the pressure transmitted from the bearing assembly 5 to the base 1, and increase a contacting area between the device and the ground, thereby significantly improve the overall stability of the lifting device during lifting and preventing the device from inclining sideways due to the shift of the gravity center.

In some embodiments, there are two third rod bodies 74 extending towards the rear of the base 1. The two third rod bodies 74 are configured to respectively bend toward a direction away from the base 1 to achieve a V-shaped arrangement.

In some embodiments, the lifting device further includes a plurality of omni-directional wheels 9, a first mounting plate 75 and a second mounting plate 76. An end of the first rod body 72 away from the second rod body 73 is provided with the first mounting plate 75. An end of the third rod body 75 away from the second rod body 73 is provided with the second mounting plate 76. The first mounting plate 75 and the second mounting plate 76 are each provided with the plurality of omni-directional wheels 9.

In some embodiments, the plurality of omni-directional wheels 9 have excellent wear resistance and shock absorption performance, and can adapt to ground environments of different roughness. Each of the plurality of omni-directional wheels 9 is independently provided with a brake assembly including a brake pedal. When the lifting device needs to be fixed, the brake pedal is pressed to lock a corresponding omni-directional wheel 9, thereby preventing the lifting device from accidentally sliding under load. When the lifting device needs to be moved, the brake pedal is loosed to allow a corresponding omni-directional wheel 9 to flexibly steer, thereby facilitating adjusting the position of the lifting device for the operator. Specific structure and arrangement of each of the omni-directional wheels 9 provided herein refer to the relevant description in Chinese patent No. CN 223429690U.

In some embodiments, the adjustment mechanism 8 includes a fixing block 81, a rotating shaft 82, a rotating block 83, a first articulated column 71, a second articulated column 84, a connecting rod 85 and an operating lever 86.

The fixing block 81 is fixedly arranged on a rear side of the base 1. The rotating shaft 82 is rotatably inserted into the fixing block 81. A middle of the rotating block 83 is fixedly connected to a first end of the rotating shaft 82. An end of each of the two supporting legs 7 close to the rotating block 83 is provided with the first articulated column 71. Two ends of the rotating block 83 are each provided with the second articulated column 84. The first articulated column 71 is connected to the second articulated column 84 through the connecting rod 85. The first end of the connecting rod 85 is movably sleeved onto the second articulated column 84. The second end of the connecting rod 85 is movably sleeved onto the first articulated column 71. The operating lever 86 is fixedly connected to a second end of the rotating shaft 82.

In this embodiment, the fixing block 81 is L-shaped. The first and second ends of the rotating shaft 82 are arranged on two sides of the fixing block 81, respectively. The rotating shaft 82 is horizontally arranged. The operating lever 86 is arc-shaped or V-shaped. The operating lever 86 has a rotation angle of 0-90°, and is configured to open toward a limiting rod 88. The first articulated column 71 is arranged on the third rod body 74.

In some embodiments, the operator applies a force to an end of the operating lever 86, causing it to rotate about the rotating shaft 82. The rotating shaft 82 is driven by the operating lever 86 to rotate in the fixing block 81. The rotating block 83 fixedly sleeved onto the rotating shaft 82 is synchronously driven to rotate about the rotating shaft 82. When the rotating block 83 rotates, the second articulated columns 84 arranged on the two ends of the rotating block 83 are configured to perform a circular motion accordingly. The connecting rod 85 is configured to pull or push the first articulated columns 71 arranged on the two supporting legs 7, so as to allow two ends of the two supporting legs 7 to rotate about the articulated shaft 12 of the base 1. By means of this, the spacing between the two supporting legs 7 is adjusted, so that when faced with users of different sizes or when used in narrow spaces, the lifting device can better adapt to such users and environments.

In some embodiments, if it is necessary to adjust the spacing between the two ends of the two supporting legs 7, the operator applies a force to one end of the operating lever 86, causing it to rotate about the rotating shaft 82. The rotating block 83 is synchronously driven to rotate about the rotating shaft 82. The second articulated columns 84 arranged on the two ends of the rotating block 83 are configured to perform a circular motion about the rotating shaft 82. When the second articulated columns 84 are away from a vertical plane where the rotating shaft 82 is located, the first articulated columns 71 on the two third rod bodies 74 are pushed by the connecting rod 85, such that the spacing between rear ends of the two third rod bodies 74 (away from the second rod body 73) is increased, and the spacing between front ends of the two first rod bodies 72 (away from the second rod body 73) is decreased. On the contrary, the operator applies a force to the other end of the operating lever 86, causing it to reversely rotate about the rotating shaft 82. When the second articulated columns 84 are close to the vertical plane where the rotating shaft 82 is located, the first articulated columns 71 on the two third rod bodies 74 are pulled by the connecting rod 85, such that the spacing between rear ends of the two third rod bodies 74 (away from the second rod body 73) is decreased, and the spacing between front ends of the two first rod bodies 72 (away from the second rod body 73) is increased.

In some embodiments, a bearing 89 is arranged between the rotating shaft 82 and the fixing block 81.

In some embodiments, an outer ring of the bearing 89 is in interference fit with the fixing block 81. An inner ring of the bearing 89 is fixedly sleeved onto the rotating shaft 82. Thus, the rotating shaft 82 is allowed to stably and smoothly rotate in the fixing block 81, while reducing the friction loss between the rotating shaft 82 and the fixing block 81, and extending the service life of the adjustment mechanism 8.

In some embodiments, a side of the fixing block 81 close to the operating lever 86 is provided with a mounting seat 87. The mounting seat 87 is located below the operating lever 86, and is internally provided with a limiting block 871 configured to be elastically retractable. A side of the limiting block 871 is configured to abut against the operating lever 86. A surface of the operating lever 86 close to the limiting block 871 is provided with a plurality of slots 861 arranged spaced apart. In response to a case that an end of the limiting block 871 is engaged with a slot 861 among the plurality of slots 861, the operating lever 86 is configured to be limited by the limiting block 871.

In some embodiments, the plurality of slots 861 are each arc-shaped. The side of the limiting block 871 is adaptable to each of the plurality of slots 861 in terms of shape. The mounting seat 87 is internally provided with an accommodating cavity to accommodate the limiting block 871. The accommodating cavity is internally provided with a spring. Under the elastic force of the spring, the side of the limiting block 871 is configured to abut against the surface of the operating lever 86 close to the limiting block 871, so as to allow the limiting block 871 to elastically extend and retract.

In some embodiments, the plurality of slots 861 include a first slot 8611 and a second slot 8612 arranged spaced apart. When the limiting block 871 is engaged with the first slot 8611, the spacing between the front ends of the first rod bodies 72 (away from the second rod body 73) on two sides of the lifting device has a maximum of H2, and the spacing between the rear ends of the third rod bodies 74 (away from the second rod body 73) on two sides of the lifting device has a minimum value. When the limiting block 871 is engaged with the second slot 8612, the spacing between front ends of the first rod bodies 72 (away from the second rod body 73) on two sides of the lifting device has a minimum of H1, and the spacing between rear ends of the third rod bodies 74 (away from the second rod body 73) on two sides of the lifting device has a maximum value.

When working, if it is necessary to adjust the spacing between the first rod bodies 72 on two sides of the lifting device, an end of the operating lever 86 is applied with pressure, causing the operating lever 86 to rotate about the rotating shaft 82. Thus, the limiting block 871 is compressed by the operating lever 86 to disengage the limiting block 871 from a slot 861 among the plurality of slots 861. The surface of the operating lever 86 moves along the limiting block 871 until the limiting block 871 is automatically engaged with another slot 861 among the plurality of slots 861 under the elastic force of the spring, thereby limiting the operating lever 86 again. As a consequence, the rotating block 83 is allowed to switch between a vertical state and a horizontal state, so as to adjust the spacing between the front ends of the first rod bodies 72 (away from the second rod body 73) and the spacing between the rear ends of the third rod bodies 74 (away from the second rod body 73) on two sides of the lifting device, enabling the lifting device to better adapt to users of different body sizes and different environments. Such a limiting structure facilitates operation. In this case, through the coordination of the limiting block 871 and the plurality of slots 861, the positioning of the operating lever 86 can be completed quickly and stably, ensuring that the operating lever 86 will not rotate unexpectedly during the operation of the lifting device, thereby enhancing the safety and reliability of the lifting device operation.

In some embodiments, the side of the fixing block 81 close to the operating lever 86 is further provided with the limiting rod 88. A surface of the operating lever 86 away from the plurality of slots 861 is provided with an arch-shaped limiting groove 862. The limiting rod 88 is configured to extend into the arch-shaped limiting groove 862.

In some embodiments, a center point of the limiting groove 862 is arranged on an axial line of the rotating shaft 82. The limiting groove 862 includes a first end 8621 and a second end 8622. When the limiting block 871 is engaged with the first slot 8611, the limiting rod 88 is exactly located on the second end 8622 of the limiting groove 862. When the limiting block 871 is engaged with the second slot 8612, the limiting rod 88 is exactly located on the first end 8621 of the limiting groove 862.

When the operating lever 86 rotates about the rotating shaft 82, an arc-shaped edge of the limiting groove 862 is configured to fit a rotation trajectory of the operating lever 86, such that a rotation range is limited by the cooperation of the limiting rod 88 and the limiting groove 862. When the limiting block 871 disengages from the first slot 8611 and moves to the second slot 8612, the limiting rod 88 is configured to move from the second end 8622 to the first end 8621 in the limiting groove 862, until the limiting block 871 is engaged with the second slot 8612, and the limiting rod 88 exactly moves to the first end 8621. At this moment, the operating lever 86 can rotate no further. On the contrary, when the limiting block 871 disengages from the second slot 8612 and moves to the first slot 8611, the limiting rod 88 is configured to move from the first end 8621 to the second end 8622 in the limiting groove 862, until the limiting block 871 is engaged with the first slot 8611, and the limiting rod 88 exactly moves to the second end 8622. At this moment, the operating lever 86 can rotate no further.

By means of such arrangement, a rotation angle of the operating lever 86 is further limited, so as to allow the operating lever 86 to precisely switch between the vertical state and the horizontal state, and to prevent structural misalignment or functional failure of the operating lever 86 caused by excessive or insufficient rotation angle. The fitting structure of the limiting rod 88 and the arc-shaped limiting slot 862, in conjunction with the limiting structures of the limiting block 871 and the plurality of slots 861, forms a double insurance. It significantly enhances the stability and accuracy of the adjustment process, and enables more precise adjustment of the spacing of the two supporting legs 7 of the lifting device.

In some embodiments, two sides of the mounting block 4 are provided with a first armrest 41, respectively. Two sides of the back plate 51 are provided with a second armrest 511, respectively. In this case, it is easier for the operator to move or adjust the lifting device by providing convenient handhold parts, such as the first armrest 41 and the second armrest 511, thereby facilitating force application and enhancing the flexibility and operational convenience during the operation.

The embodiments described above are merely preferable embodiments of the present disclosure, and are not intended to limit this disclosure. Equivalent structure replacements obtained based on the description and the accompanying figures within the spirit and principle of the present disclosure, can be directly or indirectly applied to other related arts, and shall fall within the scope of the disclosure defined by the appended claims.

What is claimed is:

1. A lifting device, comprising:
a base;
a lifting mechanism; and
two supporting legs;
wherein the lifting mechanism is arranged on the base; one of the two supporting legs is hinged to a first end of the base, and the other of the two supporting legs is hinged to a second end of the base; the two supporting legs are configured to support the base; and a spacing between the two supporting legs is adjustable.

2. The lifting device of claim 1, further comprising:
an adjustment mechanism arranged on the base;
wherein the adjustment mechanism is located between the two supporting legs, and is configured to adjust the spacing between the two supporting legs.

3. The lifting device of claim 2, wherein the adjustment mechanism comprises a fixing block, a rotating shaft, a rotating block, a connecting rod and an operating lever; the fixing block is fixedly arranged on the base; the rotating shaft is rotatably inserted into the fixing block; a middle of the rotating block is fixedly connected to a first end of the rotating shaft; the rotating block is connected to the two supporting legs through the connecting rod; a first end of the connecting rod is hinged to the rotating block; a second end of the connecting rod is hinged to the two supporting legs; and the operating lever is fixedly connected to a second end of the rotating shaft.

4. The lifting device of claim 3, wherein the adjustment mechanism further comprises a first articulated column and a second articulated column; an end of each of the two supporting legs close to the rotating block is provided with the first articulated column; two ends of the rotating block are each provided with the second articulated column; the first articulated column is connected to the second articulated column through the connecting rod; the first end of the connecting rod is movably sleeved onto the second articulated column; and the second end of the connecting rod is movably sleeved onto the first articulated column.

5. The lifting device of claim 3, wherein a side of the fixing block close to the operating lever is provided with a mounting seat; the mounting seat is located below the operating lever, and is internally provided with a limiting block configured to be elastically retractable; a side of the limiting block is configured to abut against the operating lever; a surface of the operating lever close to the limiting block is provided with a plurality of slots arranged spaced apart; and
in response to a case that an end of the limiting block is engaged with a slot among the plurality of slots, the operating lever is configured to be limited by the limiting block.

6. The lifting device of claim 5, wherein the side of the fixing block close to the operating lever is further provided with a limiting rod; a surface of the operating lever away from the plurality of slots is provided with an arch-shaped limiting groove; and the limiting rod is configured to extend into the arch-shaped limiting groove.

7. The lifting device of claim 6, wherein the operating lever is arc-shaped, and is configured to open toward the limiting rod.

8. The lifting device of claim 1, wherein each of the two supporting legs comprises a first rod body, a second rod body and a third rod body fixedly connected in sequence.

9. The lifting device of claim 1, wherein at least one of the first rod body and the third rod body is configured to bend toward a direction away from the base.

10. The lifting device of claim 1, wherein the lifting mechanism comprises a supporting rod, a sleeving rod, a bearing assembly and a drive mechanism; the supporting rod is vertically arranged on the base; the sleeving rod is movably sleeved onto the supporting rod; the bearing assembly is fixedly connected to the sleeving rod; and the drive mechanism is arranged on the base, and is configured to drive the sleeving rod to slide up and down along an outer wall of the supporting rod.
